(19) United States
(12) Patent Application Publication
(10) Pub. No.: US 2005/0251796 A1
(43) Pub. Date: Nov. 10, 2005

(54) Automatic identification and reuse of software libraries

(75) Inventors: John Squires Poelman, San Jose, CA (US); Ah-Fung Sit, San Jose, CA (US); Ryan Edmund Sue, Fremont, CA (US); Liem Gioi Tran, San Jose, CA (US); Jennifer Xia, San Jose, CA (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation, Armonk, NY (US)

(21) Appl. No.: 10/841,154

(22) Filed: May 7, 2004

(51) Int. Cl. G06F 9/44

(52) U.S. Cl. 717/163

(57) ABSTRACT

A method, apparatus and article of manufacture that implements the method, automatically identifies and reuses software libraries. In various embodiments, a first set of specified block names is received. One or more libraries of the source project which contain the blocks associated with the first set of specified block names are automatically identified to provide a first set of libraries for reuse. In some embodiments, one or more depended-upon blocks associated with the blocks of the first set of libraries are also automatically identified; and, one or more depended-upon libraries in the source project, which contain the depended-upon blocks, are automatically identified for reuse. In yet another embodiment, a reuse library is built based on static libraries of the first set of libraries and static libraries of the depended-upon libraries.

### BACKGROUND OF THE INVENTION

1. Field of the Invention

The invention generally relates to reusing software, and in particular, to the automatic identification and reuse of software libraries.

2. Description of the Related Art

Computer software development projects are often highly complex. A software development project may involve teams of software developers each working on distinct components for individual projects based on given sets of requirements. Many projects typically contain components to process common computing tasks such as network communications, string processing, database access and operating system calls. To reduce the duplication of effort involved in implementing similar logic for common tasks, software reuse based on interfaces or class libraries has become a major discipline in software engineering.

One common way to reuse software across projects or applications is through the use of procedural or object oriented Application Programming Interfaces (APIs). Portions of the reusable software are compiled into libraries, and a set of header files is provided to specify the interfaces for the exposed functions or classes. Other projects can use these libraries by including the corresponding header files within their project source code. By doing so, unresolved references to external functions or classes declared within these header files can be resolved at compile time. The object code produced for these projects can then be linked with the reusable libraries. This method works well if a software project is designed to expose all common functions or classes to other projects.

Unfortunately, software projects are not typically designed to expose all common functions or classes for reuse in other projects. Common functions or classes are often implemented in libraries for reuse internally within a project. Typically only a small number of APIs are provided to expose functions or classes for use outside of a project.

In a software project, functions or classes are typically organized in a hierarchy. A lower level function or class carries out tasks that are deemed to be more basic in functionality than a higher level function or class. Higher level functions or classes typically invoke lower level functions or classes. Typically higher level functions or classes are grouped into libraries and are exposed to other projects via the APIs. Lower level functions or classes which implement common computing functions within a project are also typically grouped into one or more libraries, but they are not typically exposed as external libraries to other projects. However, reusing lower level functions or classes could reduce software development costs.

Libraries that are not exposed to other projects are referred to as internal libraries. For a project to reuse the internal libraries of another project, software developers typically employ one of two approaches. In a first approach, a set of header files containing the declarations of the desired internal functions along with a collection of the internal libraries implementing the functions are manually identified in the source project. The internal functions may invoke other internal functions in other internal libraries. The other internal functions are referred to as depended-upon functions and the other internal libraries are referred to as depended-upon libraries. The depended-upon functions and libraries are manually identified. The target project is created and compiled from the set of header files and identified internal libraries belonging to a source project. This first approach uses a subset of the libraries of the source project. However, the effort to identify the interdependencies between functions and libraries, and thereby effectively subset the source project, is tedious and can be tremendous.

In a second approach, the project under development is compiled and packaged with all the libraries, that is, the entire set of functions, of the source project to produce one or more binary files that will be executed. The second approach reuses all the code from the source project. However, it is typically not feasible to ship the binary files of both projects due to packaging and business requirements.

Therefore, there is a need for an improved technique for reusing libraries between software projects. This technique should also automatically determine interdependencies between functions and libraries.

### SUMMARY OF THE INVENTION

To overcome the limitations in the prior art described above, and to overcome other limitations that will become apparent upon reading and understanding the present specification, various embodiments of the present invention disclose a technique for the automatic identification and reuse of software libraries. In various embodiments, a first set of specified block names is received. One or more libraries of the source project which contain the blocks associated with the first set of specified block names are automatically identified to provide a first set of libraries for reuse.

In another embodiment, one or more depended-upon blocks associated with the blocks of the first set of libraries are also automatically identified; and, one or more depended-upon libraries in the source project, which contain the referenced blocks, are automatically identified for reuse. In yet another embodiment, a reuse library is built based on static libraries of the first set of libraries and any static libraries of the depended-upon libraries.

In an alternate embodiment, a wrapper library comprising wrapper functions for the specified block names is generated. In another embodiment, a target project executable is built using the wrapper library. In yet another embodiment, a target project executable is built using at least a subset of the libraries of the reuse library.

In this way, an improved technique to identify and reuse libraries from a software project has been provided. In addition, various embodiments of this technique automatically determine dependencies between blocks, and in some more particular embodiments, functions within libraries.

### BRIEF DESCRIPTION OF THE DRAWINGS

The teachings of the present invention can be readily understood by considering the following detailed description in conjunction with the accompanying drawings, in which:

FIG. 1 depicts a high-level diagram illustrating an embodiment of a project integrator and a target project, Project A, which reuses libraries from a source project, Project B;

FIG. 2 depicts an illustrative computer system which uses various embodiments of the teachings of the present invention;

FIG. 3 depicts a flowchart of an embodiment of a technique implemented by the project integrator of FIG. 2;

FIG. 4 depicts a flowchart of an embodiment of identifying the first set of libraries;

FIG. 5 depicts a flowchart of an embodiment of generally identifying libraries based on a received set of block names by providing a list of identified libraries;

FIG. 6 depicts a flowchart of an embodiment of identifying depended-upon libraries;

FIG. 7 depicts a flowchart of an embodiment of the step of building the reuse library of FIG. 3;

FIG. 8 depicts a more-detailed flowchart of an embodiment of the result of the step of invoking the library-builder file of FIG. 7 to build the reuse library;

FIG. 9 depicts a flowchart of an alternate embodiment of the project integrator of FIG. 2 which uses a wrapper to encapsulate specified blocks;

FIG. 10 depicts a flowchart of an embodiment of the steps of generating a wrapper header file and wrapper source code of FIG. 9;

FIG. 11 depicts a flowchart of an embodiment of the step of building the reuse library of FIG. 9;

FIG. 12 depicts a flowchart of an embodiment of the result of the step of invoking the library-builder file to build the reuse library of FIG. 11;

FIG. 13 depicts a diagram illustrating an embodiment of the selection of functions to be reused from Project B, and the identification of static and dynamic libraries from Project B;

FIG. 14 depicts a high level diagram of an embodiment of the project builder and the project integrator;

FIG. 15 depicts a flowchart of an embodiment of the building of the target project and the use of the project integrator to resolve any unresolved reference errors;

FIG. 16 depicts an embodiment of a graphical user interface to allow a user to enter at least one directory name to search for libraries;

FIG. 17 depicts an exemplary Project Integrator window which was generated in response to a search from the window of FIG. 16; and

FIG. 18 depicts an exemplary window to provide a wrapper name for a block.

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to automatically identify and reuse software libraries.

In this description, a block refers to a programming construct, including, and not limited to, a function, method, class, class instance, class instance member, class instance method, procedure, subroutine, and routine. In some embodiments, a block also refers, and is not limited to, to a variable and an instance variable. In another embodiment, a block also refers to a constant and a type definition. A library comprises one or more blocks. A project comprises one or more software components. A software component refers to, and is not limited to, a source code file, a library and a header file.

Typically, a library is a static library or a dynamically-linked library. A static library is compiled with the target project and unresolved references to blocks are resolved during compilation and linking to produce an executable target file. A dynamically-linked library is used by the executable target file during execution. References to blocks that were unresolved during compilation and linking in the dynamically-linked library are resolved during execution. In some platforms, such as UNIX, dynamically-linked libraries are referred to as shared object libraries. In this document, the term dynamically-linked library also encompasses shared object libraries.

In various embodiments, the project integrator 20 is used as a tool to automatically identify the libraries to be used for a set of specified blocks, and in some more particular embodiments, functions. In other embodiments, the project integrator 20 is also used as a tool to generate a wrapper library that encapsulates the specified blocks.

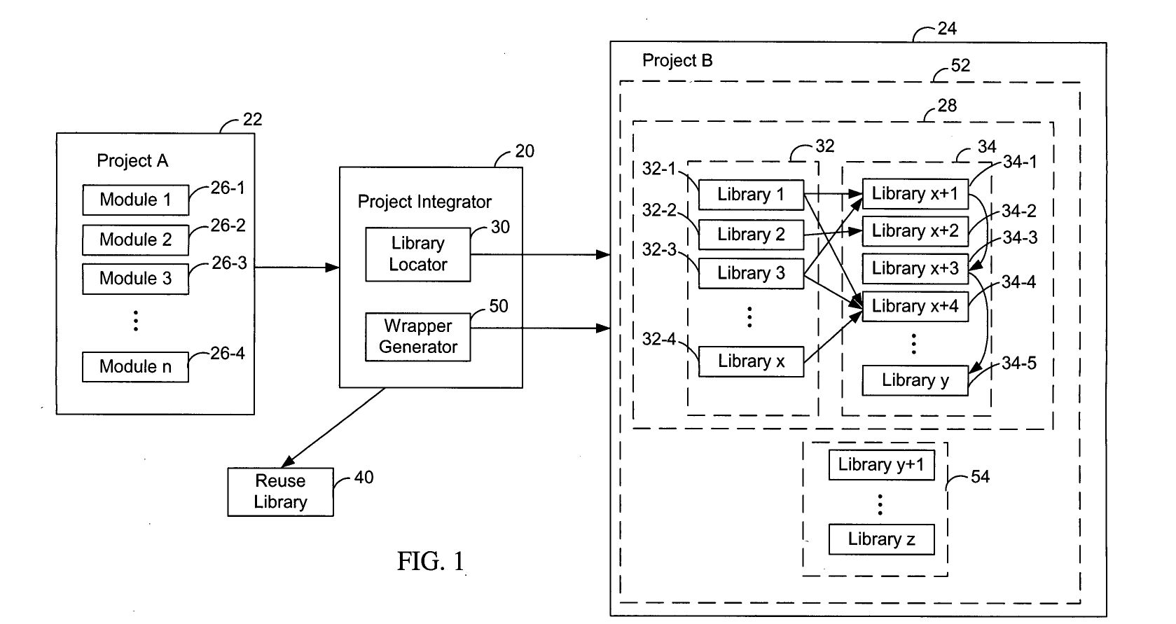

FIG. 1 depicts a Project Integrator 20 which implements an embodiment of the present inventive technique to automatically identify and reuse software libraries of a source project 24 in a target project 22. For example, as shown in FIG. 1, the target project 22, Project A, contains n internal components 26-1 to 26-4. It is desired that functions within the source project 24, Project B, be used by Project A. The Project Integrator 20 has a library locator 30. The library locator 30 receives a set of specified function names for reuse in the target project 22, and identifies a first set of libraries 32 from the source project 24 containing the functions associated with the specified function names. The first set of libraries 32 may comprise static and dynamic libraries. In this example, in FIG. 1, all of the libraries of the first set of libraries are static libraries. The Project Integrator 20 identifies any depended-upon libraries 34 from the source project 24 which are used, both directly and indirectly, by the functions in the first set of libraries. The depended-upon libraries 34 comprise static libraries, 34-1, 34-3 and 34-5, and dynamically-linked libraries, 34-2 and 34-4. The Project Integrator 20 builds a reuse library 40 based on the static libraries of the first set of libraries 32 and the static depended-upon libraries 34-1, 34-3 and 34-5. The target software project, Project A, executable is built using the reuse library 40. The depended-upon dynamically-linked libraries, 34-2 and 34-4, are used when executing the Project A executable file.

In another embodiment, the Project Integrator 20 also has a wrapper generator 50 which generates a software wrapper for the specified functions. In an alternate embodiment, the library locator 30 and wrapper generator 50 are not implemented as separate components within the project integrator.

As shown in FIG. 1, Project B has a total number of z libraries 52. In the Project B libraries, the first set of libraries 32, has x libraries, library 1 to library x, which contain one or more of the functions having the specified function names for use in Project A. The depended-upon libraries 34, that is, the next y-x libraries, library x+1 34-1 to library y 34-5, contain functions which are invoked by the first x libraries. Within the libraries 28, the arrows point to depended-upon libraries. For example, library 1 32-1 depends upon library x+1 34-1, library x+1 34-1 depends upon library x+3 34-3, and library x+3 34-3 depends upon library y 34-5. Library 2 32-2 depends upon library x+2 34-2, and libraries 1, 3 and x, 32-1, 32-3 and 32-4, respectively, all depend upon library x+4 34-4. The depended-upon libraries 34 comprise both static and dynamically-linked libraries. Libraries x+1, x+3 and y, 34-1, 34-3 and 34-5, respectively, are depended-upon static libraries. Libraries x+2 and x+4, 34-2 and 34-4, respectively, are depended-upon dynamically-linked libraries. The z-y libraries 54, library y+1 to library z, will not be used by Project A 22, either directly or indirectly.

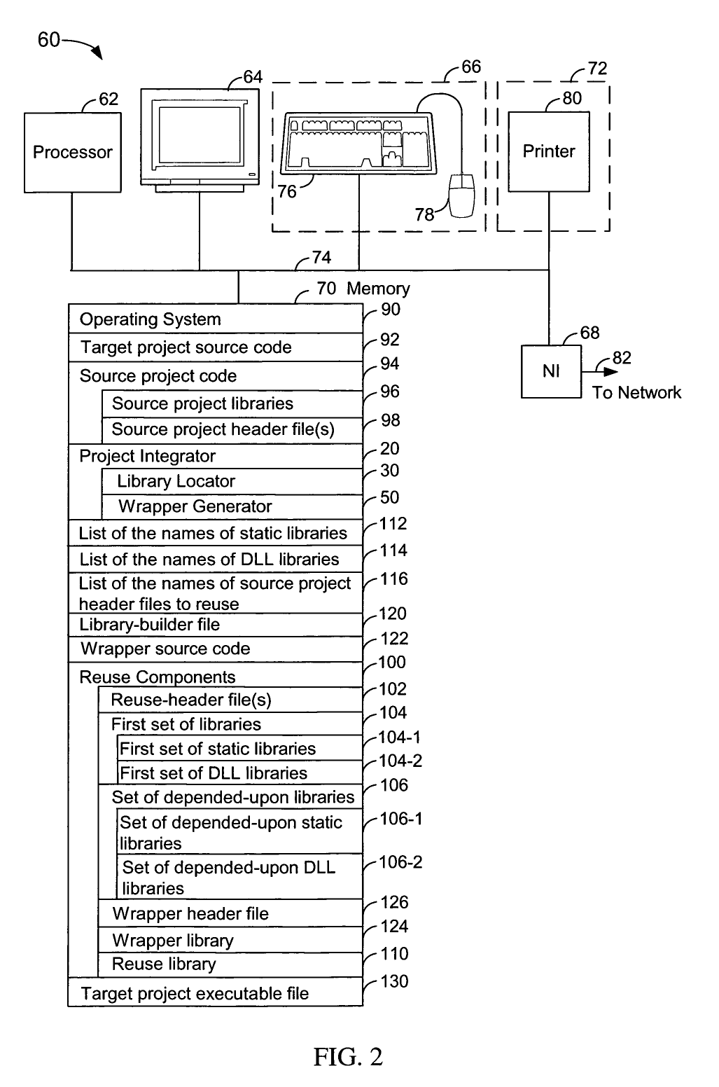

FIG. 2 depicts an illustrative computer system 60 that utilizes the teachings of various embodiments of the present invention. The computer system 60 comprises a processor 62, display 64, input interfaces (I/F) 66, communications interface 68, memory 70 and output interface(s) 72, all conventionally coupled by one or more busses 74. The input interfaces 66 comprise a keyboard 76 and mouse 78. The output interface 72 is a printer 80. The communications interface 68 is a network interface (NI) that allows the computer 60 to communicate via a network, such as the Internet. The communications interface 68 may be coupled to a transmission medium 82 such as, a network transmission line, for example, twisted pair, coaxial cable or fiber optic cable. In another exemplary embodiment, the communications interface 68 provides a wireless interface. In other words, the transmission medium is wireless.

The memory 70 generally comprises different modalities, illustratively semiconductor memory, such as random access memory (RAM), and disk drives. In some embodiments, the memory 70 stores an operating system 90, project integrator 20, target project source code 92 and source project code 94. The operating system 90, project integrator 20, target project source code 92 and source project code 94 are comprised of instructions and data. In other embodiments, any one or each of the project integrator 20, target project source code 92 and source project code 94 are stored in different computers. The specific software instructions that implement the various embodiments of the present inventive technique are typically incorporated in the project integrator 20. Generally, an embodiment of the present inventive technique is tangibly embodied in a computer-readable medium, for example, the memory 70 and is comprised of instructions which, when executed by the processor 62, cause the computer system 60 to utilize the embodiment of the present invention.

The operating system 90 may be implemented by any conventional operating system, such as AIX® (Registered Trademark of International Business Machines Corporation), UNIX® (UNIX is a registered trademark of The Open Group in the United States and other countries), WINDOWS® (Registered Trademark of Microsoft Corporation), and LINUX® (Registered trademark of Linus Torvalds).

Typically, the source project code 94 has source project libraries 96 and at least one source project header file 98. The source project header file 98 typically contains variable and function declarations.

The project integrator 20 comprises the library locator 30 and, in some embodiments, the wrapper generator 50. The project integrator 20 can be used to automatically integrate the desired blocks of the source project, Project B, with the target project, Project A. In various embodiments, as a result of executing the project integrator 20, the memory 70 also stores reuse components 100. In some embodiments, the reuse components 100 comprise at least one reuse-header file 102 which is associated with the specified block names and a copy of the libraries in a first set of libraries 104. In various embodiments, the first set of libraries comprises a first set of static libraries 104-1 and a first set of dynamically-linked (DLL) libraries 104-2. In some embodiments, the reuse components 100 further comprise a set of depended-upon libraries 106 which comprises a set of depended-upon static libraries 106-1, if any, and a set of depended-upon dynamically-linked (DLL) libraries 106-2, if any. The reuse-header files 102 are header files from the source project which are to be used in the target project.

In various embodiments, the memory 70 also stores a list 112 of the names of the static libraries comprising the first set of static libraries 104-1 and the set of depended-upon static libraries 106-1. In some embodiments, the memory also stores a list 114 of the names of the set of dynamically-linked libraries 106 which comprises the names of the first set of dynamically-linked libraries 106-1 and the names of the set of depended-upon dynamically-linked libraries 106-2. In other embodiments, a list 116 of the names of the source project header files to reuse is also stored. In some embodiments, the memory 70 stores a library-builder file 120 that is used, at least in part, to build the reuse library 110. In various embodiments, the library-builder file 120 builds the reuse library by linking the first set of static libraries 104-1 and the set of depended-upon static libraries 106-1.

In some embodiments, the memory 70 stores wrapper source code 122, and the reuse components 100 further comprise a wrapper library 124 and a wrapper header file 126. The wrapper source code 122 and wrapper library 124 encapsulate the specified blocks within the first set of libraries from the source project. In some embodiments, the library-builder file 120 is also used to compile the wrapper source code 122 to build the wrapper library 124.

In some embodiments, the memory 70 stores the target project executable file 130 which is produced by the compilation and linking of the target project source code 92 with the reuse library 110. In various embodiments, to install the target project on a computer system, the software package to execute the target project comprises the target project executable file 130, the first set of dynamically-linked libraries 104-2 of the first set of libraries, if any, and the set of depended-upon dynamically-linked libraries 106-2 from the source project 94.

In various embodiments, the memory 70 may store a portion of the software instructions and/or data for any of the operating system 90, project integrator 20, target project source code 92, source project code 94, reuse components 100, list of the names of the static libraries 112, list of the names of the dynamically-linked libraries 114, list of the names of the source project header file(s) to reuse 116, the library-builder file 120 and wrapper source code 122 in semiconductor memory, while other portions are stored in disk memory.

Although various embodiments of the present inventive technique are described with respect to the C-language and UNIX programming environment, some embodiments of the present inventive technique may also be applied to reuse libraries written in other languages, and may be used in other programming environments.

Various embodiments of the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over a network. The article of manufacture in which the code is implemented also encompasses transmission media, such as a network transmission line and wireless media. Those skilled in the art will recognize that many modifications may be made to this configuration without departing from the scope of the present invention.

Those skilled in the art will recognize that the exemplary computer system illustrated in FIG. 2 is not intended to limit the present invention. Other alternative hardware environments may be used without departing from the scope of the present invention.

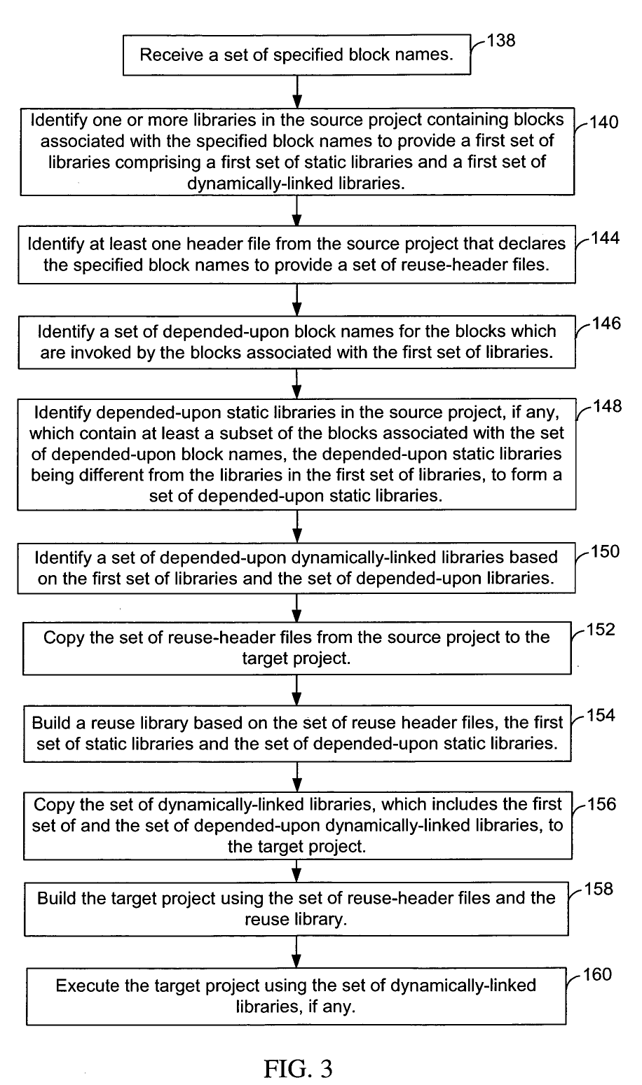

FIG. 3 depicts a flowchart illustrating an embodiment of a technique implemented by the project integrator of FIG. 2. In this embodiment, no wrapper is used to encapsulate the specified blocks from the source project. The target project invokes the specified blocks using the same names as the blocks used in the source project.

In step 138, the project integrator receives a set of specified block names. The set of specified block names contains the names of the blocks that are to be reused.

In step 140, in the project integrator, the library locator identifies one or more libraries in the source project containing blocks associated with the specified block names to provide a first set of libraries. In one embodiment, the first set of libraries comprises a first set of static libraries. The names of the libraries in the first set of static libraries are stored in the list of names of the static libraries, which may be a file. In an alternate embodiment, the first set of libraries also comprises a first set of dynamically-linked libraries. The names of the first set of dynamically-linked libraries are stored in the list of names of the dynamically-linked libraries.

In some embodiments, the first set of libraries comprises at least one static library, and no dynamically-linked libraries. Alternately, the first set of libraries comprises at least one static library and at least one dynamically-linked library. In another alternate embodiment, the first set of libraries comprises at least one dynamically-linked library and no static libraries.

In step 144, the library locator identifies at least one header file from the source project that declares the specified block names to provide a set of reuse-header files. The names of the reuse-header files are stored in the list of names of the source project header files to reuse, which may be a file. In some embodiments in the UNIX environment, a grep command is used to identify the reuse-header files as follows:
grep−1 blockname*.h.
In the grep command above, the block name is specified as the “blockname” and one or more header files, with a “.h” extension are searched for the specified block name. The “−1” option causes the names of the files with matching lines to be displayed.

In step 146, the library locator identifies a set of depended-upon block names which are invoked by the blocks associated with the first set of libraries. The set of depended-upon block names comprises the names of those blocks which are invoked, directly or indirectly, by the blocks associated with the set of specified block names.

In step 148, the library locator identifies depended-upon static libraries, if any, in the source project which contain at least a subset of the blocks associated with the set of depended-upon block names. The depended-upon static libraries are different from the libraries in the first set of libraries and form a set of depended-upon static libraries. The names of the depended-upon static libraries are stored in the list of names of static libraries. In another embodiment, steps 146 and 148 are combined.

In step 150, the library locator identifies a set of depended-upon dynamically-linked libraries based on the first set of libraries, both static and dynamically-linked, and the set of depended-upon static libraries. The set of depended-upon dynamically-linked libraries contains blocks that are linked and loaded when the software is executed. The names of the depended-upon dynamically-linked libraries are stored in the list of names of the depended-upon dynamically-linked libraries. The set of depended-upon dynamically-linked libraries may be empty.

In step 152, the set of reuse-header files is copied from the source project to the target project based on the list of source project header files to reuse. Alternately, the set of reuse-header files is copied as part of step 154.

In step 154, the project integrator builds a reuse library based on the reuse-header files, the first set of static libraries and the set of depended-upon static libraries. In a more particular embodiment, the reuse library is built by compiling the reuse-header files, and statically linking against the first set of static libraries and the set of depended-upon static libraries. In some embodiments, the project integrator uses the list of names of the static libraries when building the reuse library. In another embodiment, the project integrator builds the reuse library from copies of the set of reuse-header files, copies of the libraries of the first set of libraries and copies of the libraries of the set of depended-upon static libraries. Alternately, the project integrator builds the reuse library based on the set of reuse-header files, the first set of static libraries and the set of depended-upon static libraries, directly from the source project, rather than copies. In yet another embodiment, the project integrator builds the reuse library using some libraries directly from the source project and using copies of other libraries.

In step 156, the set of dynamically-linked libraries, which comprises the first set of dynamically-linked libraries and the set of depended-upon dynamically-linked libraries, is copied to the target project. When the target project is executing, the dynamically-linked libraries are linked to the target project at that time. In some embodiments, the project integrator uses the list of the names of the dynamically-linked libraries when copying the set of dynamically-linked libraries. Alternately, step 156 is omitted and the target project links to the dynamically-linked libraries in the source project

In step 158, the developer, or alternately the project integrator, builds the target project using the reuse-header files and the reuse library. More particularly, the target project is built by compiling the target project source code 92 (FIG. 2) with the set of reuse header files and statically linking against the reuse library. In another alternate embodiment step 154 is omitted, and in step 158, the developer or the project integrator builds the target project to produce an executable file by compiling the target project source code with the set of reuse-header files and statically linking against the first set of static libraries and the set of depended-upon static libraries.

In step 160, the target project is executed and linked to the set of dynamically-linked libraries, if any, of the reuse components of the target project. Alternately, step 156 is omitted, and the target project links to the set of dynamically-linked libraries in the source project.

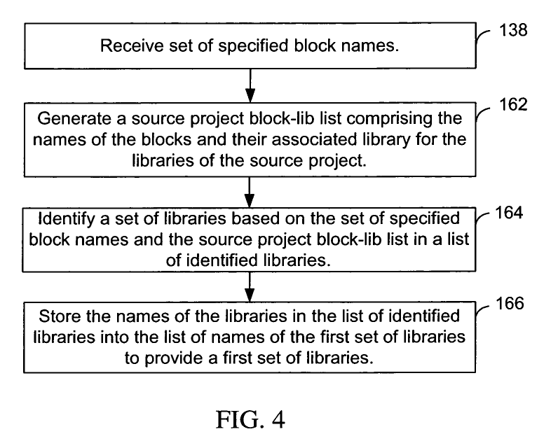

FIGS. 4, 5 and 6 illustrate various embodiments of the identification of libraries. The various embodiments of FIGS. 4, 5 and 6 can be used to identify static, and alternately, dynamically-linked libraries.

FIG. 4 depicts a flowchart of an embodiment of identifying the first set of libraries. In step 138, a set of specified block names is received. In some embodiments, steps 162-166 implement step 140 of FIG. 3. In step 162, a source project block-lib list comprising the names of the blocks and their associated library of the source project is generated. The associated library of a block name is the library which contains the code implementing the block.

In step 164, a set of libraries is identified, in a list of identified libraries, based on the set of specified block names and the source project block-lib list. The identified libraries contain one or more of the blocks of the set of specified block names. In step 166, the names of the libraries in the list of identified libraries is stored in the list of names of the first set of libraries to provide a first set of libraries.

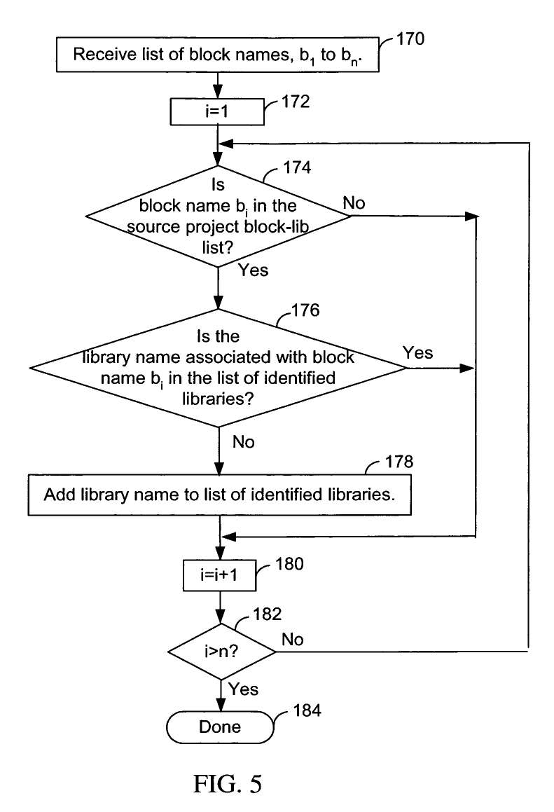

FIG. 5 depicts a flowchart of an embodiment of generally identifying libraries, by providing a list of identified libraries, based on a received set of block names and the block-lib list. In various embodiments, the flowchart of FIG. 5 implements step 164 of FIG. 4. In step 170, a set of block names, b₁ to bₙ, is received. In step 172, a counter i is set equal to one, and a list of identified libraries is emptied. The counter will be used to increment through the n block names. Step 174 determines whether block name bᵢ is in the source project block-lib list. When block name bᵢ is in the source project block-lib list, step 176 determines whether the library name associated with block name bᵢ is in the list of identified libraries. When the library name associated with block name bᵢ is not in the list of identified libraries, in step 178, that library name is added to the list of identified libraries. In step 180, the counter i is incremented by one. Step 182 determines whether all the received block names have been checked. Step 182 determines whether the counter i is greater than n, the maximum number of received block names. If so, in step 184, the process is done because the libraries associated with the received block names have been identified.

When step 174 determines that the block name bᵢ is not in the source project block-lib list, step 174 proceeds to step 180. When step 176 determines that the library name associated with block name bᵢ is in the list of identified libraries, step 176 proceeds to step 180. When step 182 determines that the value of the counter i is not greater than n, step 182 proceeds to step 174.

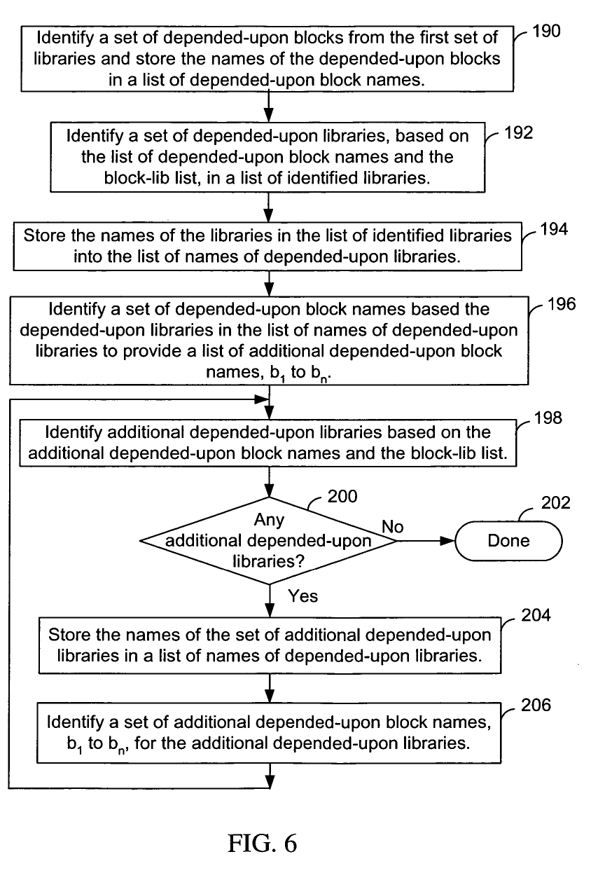

FIG. 6 depicts a flowchart of an embodiment of identifying depended-upon libraries. In various embodiments, the flowchart of FIG. 6 implements steps 146 and 148 of FIG. 3. In step 190, a set of depended-upon blocks is identified from the first set of libraries, and the names of the depended-upon blocks are stored in a list of depended-upon block names. The depended-upon block names are b₁ to bₙ. In step 192, a set of depended-upon libraries is identified based on the list of depended-upon block names and the source project block-lib list. The names of the libraries of the set of depended-upon libraries are stored in a list. In various embodiments, the technique of the flowchart of FIG. 5 is used to identify the depended-upon libraries. In this embodiment, the list of depended-upon block names is supplied to the flowchart of FIG. 5, and the block-lib list has been generated. The technique of the flowchart of FIG. 5 provides a list of identified library names. In step 194, the names of the identified libraries in the list of identified library names are stored in the list of names of depended-upon libraries. In step 196, a set of depended-upon block names is identified based on the depended-upon libraries in the list of names of depended-upon libraries to provide a list of additional depended-upon block names, b₁ to bₙ. In step 198, additional depended-upon libraries are identified based on the additional depended-upon block names. In various embodiments, the technique of the flowchart of FIG. 5 is used to identify the libraries. Step 200 determines if any additional depended-upon libraries are found. If not, in step 202, the process ends. When additional depended-upon libraries are found, in step 204, the names of the additional depended-upon libraries are stored in the list of names of depended-upon libraries. In step 206, a set of additional depended-upon block names, b₁ to bₙ, for the additional depended-upon libraries is identified. Step 206 proceeds back to step 198.

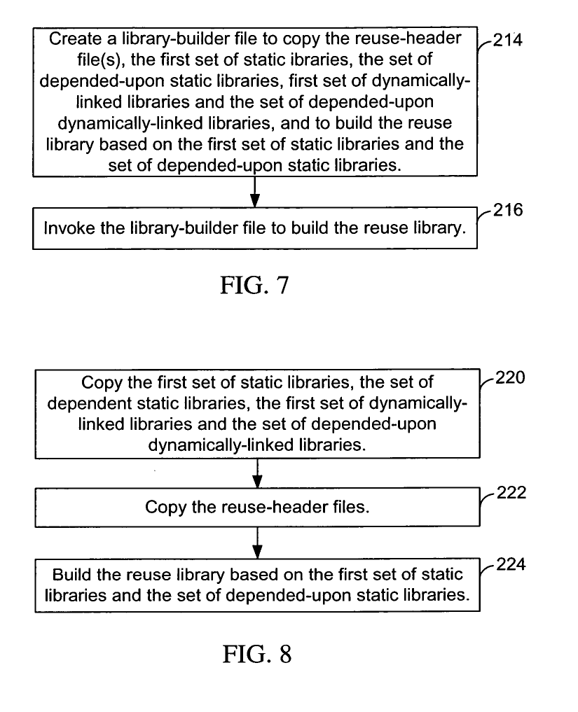

FIG. 7 depicts a flowchart of an embodiment of building the reuse library of step 154 of FIG. 3. In step 214, the project integrator creates the library-builder file to build the reuse library based on the first set of static libraries, and the set of depended-upon static libraries. In some embodiments, the library-builder file also copies the reuse-header files, the first set of static libraries, the first set of dynamically-linked libraries, the set of depended-upon static libraries, and the set of depended-upon dynamically-linked libraries to the target project. In step 216, the library-builder file is invoked to build the reuse library. In some embodiments, the library-builder file is a makefile. However, the library-builder file is not meant to be limited to a makefile, and the library-builder may be implemented using various scripts or other types of files.

FIG. 8 depicts a flowchart of an embodiment of the result of invoking the library-builder file to build the reuse library. In step 220, the first set of static libraries, the first set of dynamically-linked libraries, the set of depended-upon static libraries and the set of depended-upon dynamically-linked libraries are copied to a designated location for use by the target project. In one embodiment, the library-builder file copies the static libraries using the list of names of static libraries, and copies the dynamically-linked libraries using the list of names of dynamically-linked libraries.

In step 222, in some embodiments, the set of reuse-header files is copied in accordance with the list of names of the source project header files to reuse. In step 224, the reuse library is built based on the first set of static libraries and the set of depended-upon static libraries.

In an alternate embodiment, the first set of libraries and the depended-upon static libraries are not copied to the target project, and step 154 of FIG. 3 builds the reuse library directly from the source project. In step 158 of FIG. 3, the dynamically-linked libraries are not copied, and the target project is linked to the dynamically-linked libraries in the source project.

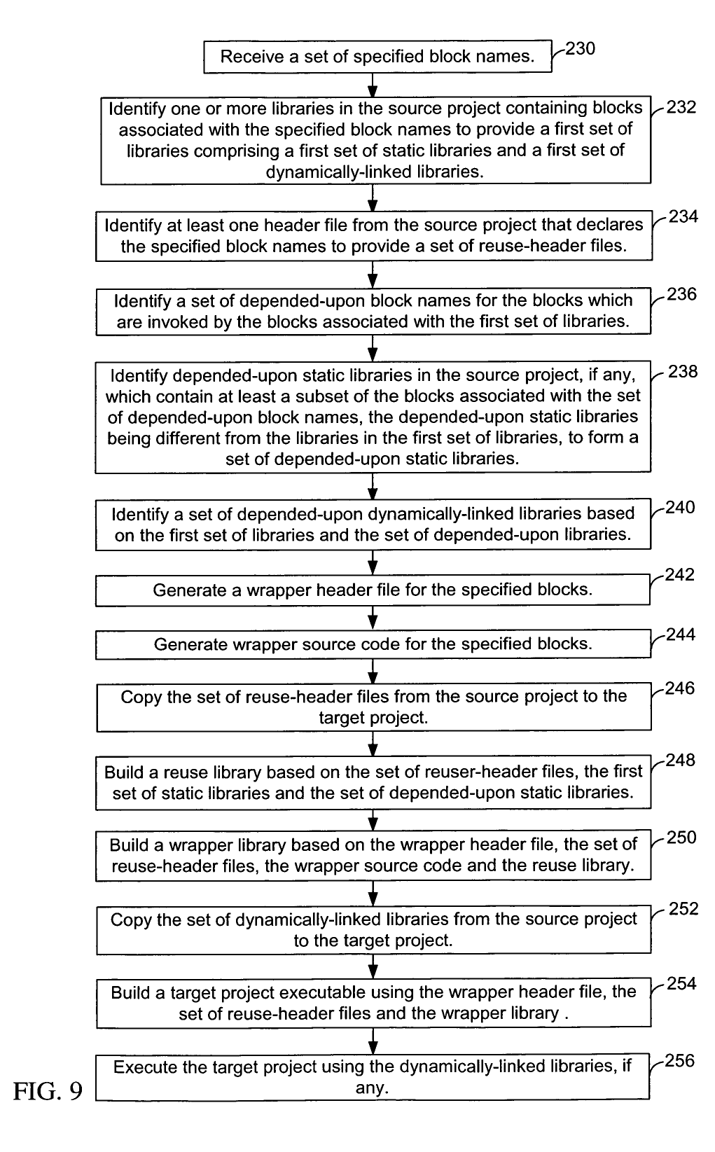

FIG. 9 depicts a flowchart illustrating an alternate embodiment which uses wrappers to encapsulate the specified blocks. The wrappers provide a level of isolation between the target project and the reused blocks. For example, if the name of a reused block changes in the source project, the wrapper source code is changed, rather than the source code in the target project. The user can regenerate new wrapper source code or modify the existing wrapper source code. Alternately, the project integrator can generate new wrapper source code. Steps 230-240 of FIG. 9 are the same as steps 140-150 of FIG. 3, respectively, and will not be further described.

In step 242, a wrapper header file is generated for the specified blocks. In step 244, wrapper source code is generated to encapsulate the specified blocks. In an alternate embodiment, steps 242 and 244 are combined. In step 246, the set of reuse-header files is copied from the source project to the target project based on the list of the names of the source project header files to reuse. In step 248, a reuse library is built based on the set of reuse-header files, the first set of static libraries, and the set of depended-upon static libraries. In step 250, a wrapper library is built based on the wrapper header file, the wrapper source code, the set of reuse-header files and the reuse library. More particularly, the wrapper library is built by compiling the wrapper source code, wrapper header file and the set of reuse-header files, and statically linking against the reuse library. Alternately, step 248 is omitted, and step 250 builds the wrapper library based on the wrapper header file, the wrapper source code, the set of reuse-header files, the first set of static libraries, and the set of depended-upon static libraries. More particularly, the wrapper library is built by compiling the wrapper source code, wrapper header file and the set of reuse-header files, and statically linking against the first set of static libraries and the set of depended-upon static libraries.

In step 252, the set of dynamically-linked libraries is copied from the source project to the target project. Alternately, step 252 is combined with step 248 or step 246. In step 254, a target project executable is built using the wrapper header file, the reuse-header files, and the wrapper library. In step 256, the target project is executed using the dynamically-linked libraries, if any, in the target project.

In another alternate embodiment, steps 248 and 250 are omitted, and the target project is built directly by compiling the target project with the wrapper header file, the set of reuse-header files, the wrapper source code, and statically linking to the first set of static libraries and the set of depended-upon static libraries.

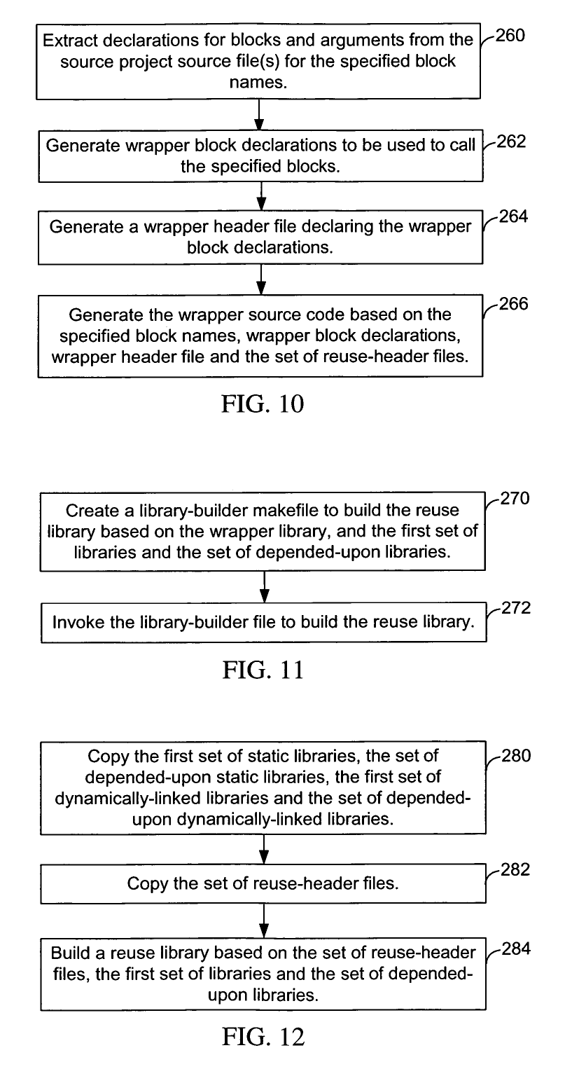

FIG. 10 depicts a flowchart of an embodiment of the steps of generating a wrapper header file and wrapper source code of steps 242 and 244, respectively, of FIG. 9. In step 260, declarations for blocks and arguments are extracted from the source project source file(s) for the specified block names. Typically, the source project has header files which declare the blocks and their arguments. The block declarations and block arguments may be extracted from the header file(s). The source project header files are searched, and the entire declaration of a specified block is read to provide an extracted block declaration. The extracted block declarations typically comprise, for a specified block name, an extracted block return type, the specified or extracted block name, extracted block argument names and extracted block argument types.

In step 262, wrapper block declarations, which are to be used to call the specified blocks, are generated. The wrapper block declarations comprise a wrapper block return type, the wrapper block name, wrapper argument names and wrapper argument types. The wrapper block declarations may be explicitly specified by a user, or automatically generated by, for example, modifying the extracted block names and arguments. The wrapper block declarations are used by the target project to call the specified blocks. The wrapper block return type is typically the same as or equivalent to the extracted block return. In some embodiments, a prefix is added to the extracted block and arguments names to provide the wrapper block and wrapper argument names for the wrapper block declaration. The wrapper argument types are typically the same as or equivalent to the extracted block argument types. The wrapper block declaration is added to the wrapper header file. In other embodiments, different prefixes are added to the block names and arguments. Alternately, the specified block names may be modified by, for example, changing the capitalization to provide wrapper block names. In an alternate embodiment, the types in the wrapper declaration, may be changed to a compatible type.

In step 266, wrapper source code is generated based on the specified block names, wrapper block declarations, wrapper header file and the reuse-header files. Include statements for the reuse-header files containing the specified block declarations are generated. An include statement for the wrapper header source file is also generated. For each wrapper block declaration, code is generated to invoke its associated specified block.

FIG. 11 depicts a flowchart of an embodiment of building the reuse library of step 248 of FIG. 9. In step 270, a library-builder file is created to build the reuse library based on the first set of static libraries and the set of depended-upon static libraries. In step 272, the library-builder file is invoked to build the reuse library.

In another embodiment, the library-builder file also copies the set of static libraries and the set of dynamically-linked libraries to the target project. In yet another embodiment, the library-builder file also copies the reuse-header files to the target project.

FIG. 12 depicts a flowchart of an embodiment of the result of the step of invoking the library-builder file to build the reuse library of FIG. 11. In step 280, the first set of libraries, both static and dynamically-linked, the set of depended-upon static libraries and the set of depended-upon dynamically-linked libraries are copied to the target project for use by the target project. In step 282, the set of reuse-header files are copied. In step 284, a reuse library is built based on the set of reuse-header files, the first set of static libraries and the set of depended-upon static libraries.

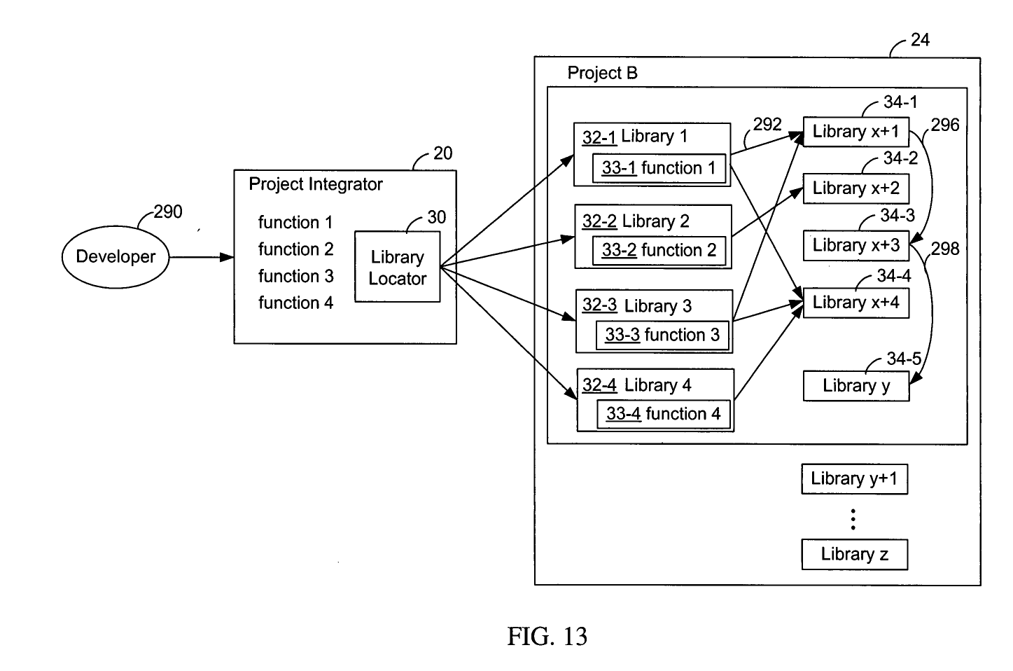

FIG. 13 depicts a diagram illustrating an embodiment of the selection of functions to be reused from the exemplary source project, Project B 24, and the identification of static and dynamic libraries. A developer 290 identifies to the project integrator 20 those functions from Project B that are to be reused by Project A. The developer 290 can supply a list of specified function names to the project integrator 20. In this example, the list of specified function names comprises function 1, function 2, function 3 and function 4. Alternately, the identification of desired functions can be implemented using a graphical user interface (GUI) which displays all the function names of Project B, or using an application programming interface (API).

In the project integrator 20, the library locator 30 identifies the libraries of project B that contain the specified functions. Library 1 32-1 contains function 1 33-1, library 2 32-2 contains function 2 33-2, library 3 32-3 contains function 3 33-3, and library 4 32-4 contains function 4 33-4. For example, in some embodiments using the UNIX operating system, an “nm” command can be used to identify the names of the functions in each library in project B, and whether that function is implemented in a library. For each specified function name, the libraries' functions' names can be searched to identify the library containing the code for the specified function name to provide a first set of libraries. A function is considered to be defined if the code for that function is in that library.

After identifying the libraries, both static and dynamically-linked, containing the functions having the specified function names, the depended-upon functions and libraries are identified. For each library in the first set of libraries, all of the functions used by the library are identified, and for a function that is not defined in a library, the other libraries of Project B are searched for that function name to identify any additional libraries, also referred to as depended-upon libraries, that will be used. However, in some embodiments, if an undefined function is known to be defined in certain utilities, for example, the functions of stdio.h, those functions are omitted from the search. The library locator generates the list of static library names containing the names of the first set of static libraries and the depended-upon static libraries.

For example, library 1 32-1 contains the code for function 1. As indicated by arrow 292, library 1 references at least one function that is defined in library x+1 34-1. Thus, library x+1 34-1 is a depended-upon library. Library x+1 34-2 is searched for function names, and the library locator identifies the code for at least one referenced function name in library x+1 34-1 in library x+3 34-3 as shown by arrow 296. Therefore library x+3 34-3 is a depended-upon library. In addition, the library locator identifies the code for at least one referenced function name in library x+3 34-3 in library y 34-5, as shown by arrow 298. Therefore, library y 34-5 is another depended-upon library.

The project integrator also identifies depended-upon dynamically-linked libraries, if any, and generates the list of the names of the dynamically-linked libraries. In one embodiment, a utility is used to list the path names of all shared objects that would be loaded for each library. For example, in one embodiment, the UNIX ldd command is used. Alternately, other utilities may be used to identify the depended-upon dynamically-linked libraries.

For example, libraries x+2 and x+4, 34-2 and 34-4, respectively, are depended-upon dynamically-linked libraries. For each library name of the first set of libraries, a UNIX ldd command is issued. For library 1 32-1, the name of library x+4 34-4 is returned. The ldd command is issued for library 2 32-2 and the name of library x+2 34-2 is returned. For libraries 3 and 4, 32-3 and 32-4, respectively, the name of library x+4 34-4 is also returned.

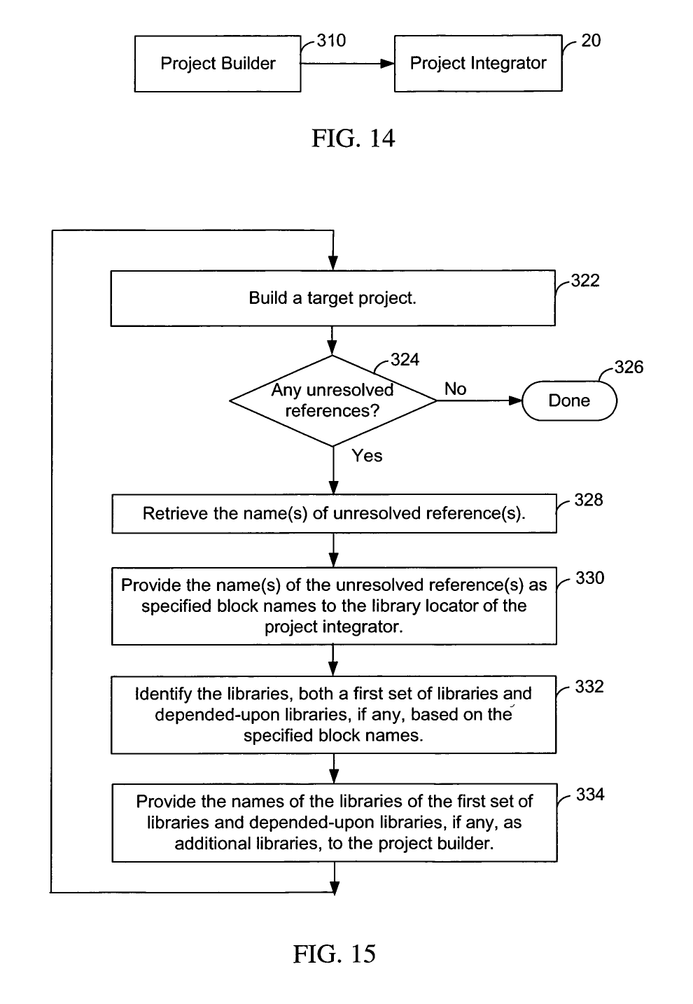

FIG. 14 depicts a high level diagram of an embodiment of a project builder 310 and the project integrator 20. The project builder 310 builds a target project. When the project builder 310 has an unresolved reference error, the project integrator 20 is invoked. The names of the unresolved references are passed as specified block names to the project integrator 20. The project integrator 20, as described above, automatically identifies the library(ies) containing the blocks associated with the unresolved block names, and supplies those library names to the project builder 310. The project builder 310 builds the target project using the supplied library names.

FIG. 15 depicts a flowchart of an embodiment of the building of the target project and the use of the project integrator to resolve unresolved reference errors. In step 322, a target project is built. In some embodiments, the project builder builds the target project. Alternately, the project integrator builds the target project. Step 324 determines whether there were any unresolved reference errors in the build. When there are no unresolved reference errors, the process ends in step 326. When the build has one or more unresolved reference errors, in step 328, the names of the one or more unresolved references are retrieved. In step 330, the names of the one or more unresolved references are provided to the library locator of the project integrator as specified block names. In step 332, the library locator identifies the libraries, both a first set of libraries associated with the specified block names and any depended-upon libraries, and these libraries are referred to as additional libraries. In some embodiments, step 332 comprises steps 140 to 150 of FIG. 3. In step 334, the names of the libraries of the first set of libraries and depended-upon libraries, if any, and the names of the reuse-header file(s) are provided to the project builder. In some embodiments, the project integrator of the flowchart of FIG. 3 is modified to perform step 334 after step 150. Alternately, when the project integrator is building the target project, step 334 is omitted. In step 322, the target project is built using the names of the additional libraries.

In another alternate embodiment which uses wrappers, step 332 comprises steps 232 to 244 of FIG. 9; and step 334 provides the names of the first set of libraries and depended-upon libraries, if any, the name(s) of the reuse-header file(s), the wrapper source file, and the wrapper header file to the project builder. In some embodiments, the project integrator of the flowchart of FIG. 9 is modified to perform step 334 after step 244. Step 322 re-builds the target project using the first set of libraries and depended-upon libraries, if any, the reuse-header file(s), the wrapper source file, and the wrapper header file.

In some embodiments, the project integrator has a graphical user interface. In various embodiments, the graphical user interface allows a user to browse a source project for blocks of interest.

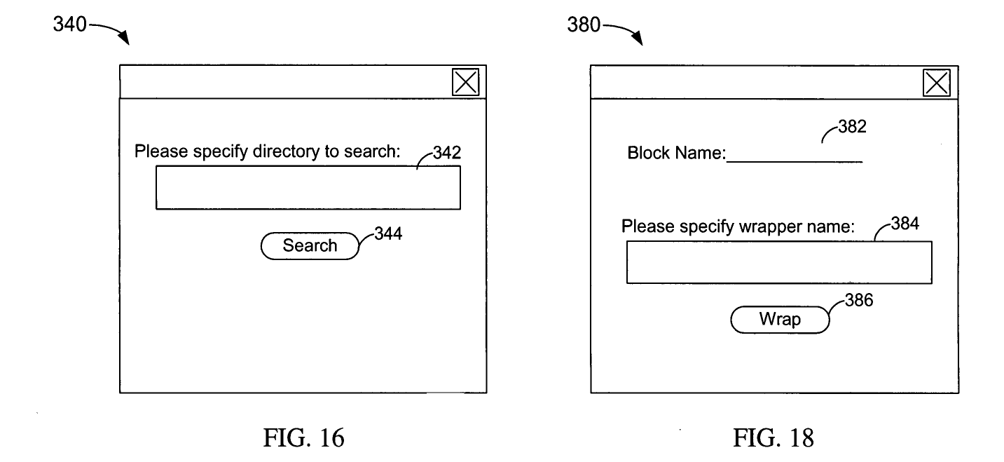

FIG. 16 depicts an embodiment of a graphical user interface 340 to allow a user to enter at least one directory name to search for libraries. The user specifies a directory of the source project to search in text box 342, and presses a search button 344 to initiate the search.

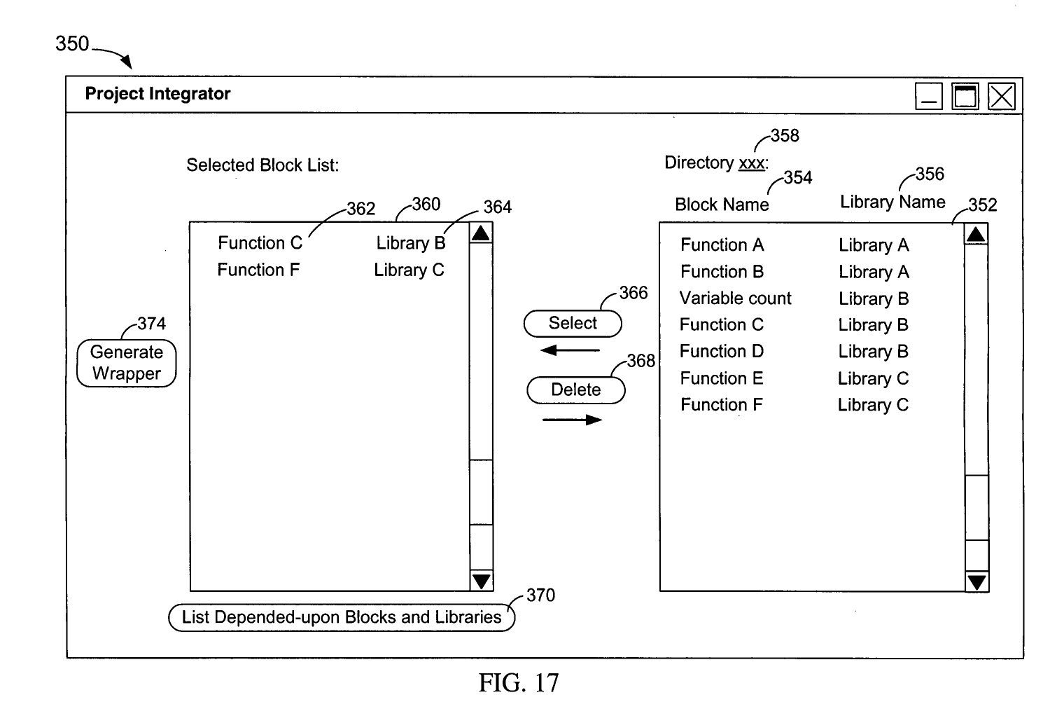

FIG. 17 depicts an exemplary Project Integrator window 350 which was generated in response to the search in the window of FIG. 16. In a first scrolling list 352, the block names 354 and respective library names 356 which are contained in the specified directory 358 are listed. A second scrolling list 360 provides a selected block list which contains the names of the blocks 362 and libraries 364 which the user has selected to reuse. The names of the blocks comprise a set of specified block names, and the names of libraries form a first set of library names. The user selects a desired block name from the first scrolling list 352 and activates a select button 366 to move that block name to the selected block list 360. The user can delete a block from the selected block list 360 by selecting a block name in the selected block list 360 and activating the delete button 368. When a “List Depended-upon Blocks and Libraries” button 370 is activated, the depended-upon blocks and libraries of the selected blocks are displayed, in some embodiments, in the selected block list 360. The depended-on libraries are identified using any of the embodiments described above. A “Generate Wrapper” button 374 activates a window to generate a wrapper for a selected block.

FIG. 18 depicts an exemplary window 380 to provide a wrapper name for a block. The name 382 of the selected block is displayed. The user specifies the wrapper name in a text box 384, and then presses the “Wrap” button 386 to generate a wrapper for the selected block.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended thereto.

1. A method of reusing software from a source project, comprising:
receiving a first set of specified block names; and
automatically identifying one or more libraries in the source project which contain blocks having the specified block names to provide a first set of libraries for reuse.

2. The method of claim 1 further comprising:
automatically identifying one or more depended-upon block names associated with the blocks of the first set of libraries; and
automatically identifying one or more depended-upon libraries, in the source project, which contain blocks having the one or more depended-upon block names for reuse.

3. The method of claim 2 further comprising:
building a reuse library comprising static libraries of the first set of libraries and any depended-upon static libraries of the one or more depended-upon libraries.

4. The method of claim 3 further comprising:
generating a wrapper library comprising wrappers for the specified block names and the reuse library; and
building a target project based on the wrapper library.

5. The method of claim 4 further comprising:
creating wrapper source code to generate the wrapper library comprising a wrapper function for each of the specified block names, wherein said generating generates the wrapper library, at least in part, based on the wrapper source code, the reuse library and reuse-header files.

6. The method of claim 3 further comprising:
generating a library-builder file to build the reuse library.

7. The method of claim 3 further comprising:
building an executable target software project based on, at least in part, the reuse library.

8. The method of claim 7 further comprising:
when said building of the executable target software project has an unresolved reference error, the unresolved reference having a name, supplying the name of the unresolved reference as a specified block name, and repeating said receiving, automatically identifying one or more libraries, automatically identifying one or more depended-upon block names and automatically identifying one or more depended-upon libraries, to provide one or more additional libraries associated with the name of the unresolved reference.

9. The method of claim 8 further comprising:
rebuilding the reuse library with the one or more additional libraries; and
repeating said building of the executable target software project.

10. The method of claim 1 wherein said receiving further comprises:
generating a graphical user interface comprising a list of the names of the blocks of the first set of libraries; and
selecting from the list of the names of the blocks to provide at least one block name of the first set of specified block names.

11. The method of claim 1 further comprising:
specifying at least one block name via a graphical user interface to provide the first set of specified block names; and
displaying the names of the libraries of the first set of libraries on the graphical user interface.

12. The method of claim 10 further comprising:
in response to a user activation, generating a wrapper for the at least one block name of the first set of specified block names.

13. An apparatus for reusing software from a source project, comprising:
a processor; and
a memory storing one or more instructions that:
receive a first set of specified block names; and
automatically identify one or more libraries in the source project which contain blocks having the specified block names to provide a first set of libraries for reuse.

14. The apparatus of claim 13 wherein said one or more instructions further comprise instructions that:
automatically identify one or more depended-upon block names associated with the blocks of the first set of libraries; and
automatically identify one or more depended-upon libraries, in the source project, which contain blocks having the one or more depended-upon block names for reuse.

15. The apparatus of claim 14 wherein said one or more instructions further comprise instructions that:
build a reuse library comprising static libraries of the first set of libraries and any depended-upon static libraries of the one or more depended-upon libraries.

16. The apparatus of claim 15 wherein said one or more instructions further comprise instructions that:
generate a wrapper library comprising wrapper blocks for the specified block names.

17. An article of manufacture comprising a computer program usable medium embodying one or more instructions executable by a computer for performing a method of reusing software from a source project, said method comprising:
receiving a first set of specified block names; and
automatically identifying one or more libraries in the source project which contain blocks having the specified block names to provide a first set of libraries for reuse.

18. The article of manufacture of claim 17 wherein said method further comprises:
automatically identifying one or more depended-upon block names associated with the blocks of the first set of libraries; and
automatically identifying one or more depended-upon libraries, in the source project, which contain blocks having the one or more depended-upon blocks for reuse.

19. The article of manufacture of claim 18 wherein said method further comprises:
building a reuse library comprising static libraries of the first set of libraries and any depended-upon static libraries of the one or more depended-upon libraries.

20. The article of manufacture of claim 19 wherein said method further comprises:
generating a wrapper library comprising wrappers for the specified block names and the reuse library; and
building a target project based on the wrapper library.

21. The article of manufacture of claim 20 wherein said method further comprises:
creating wrapper source code to generate the wrapper library comprising a wrapper block for each of the specified block names;
wherein said generating generates the wrapper library, at least in part, based on the wrapper source code, the reuse library and reuse header files.

22. The article of manufacture of claim 19 wherein said method further comprises:
generating a library-builder file to build the reuse library.

23. The article of manufacture of claim 19 wherein said method further comprises:
building an executable target software project based on, at least in part, the reuse library.

24. The article of manufacture of claim 23 wherein said method further comprises:
when said building of the executable target software project has an unresolved reference error, supplying a name of the unresolved reference as a specified block name, and repeating said receiving, automatically identifying one or more libraries, automatically identifying one or more depended-upon block names, and automatically identifying one or more depended-upon libraries, to provide one or more additional libraries associated with the name of the unresolved reference.

25. The article of manufacture of claim 24 wherein said method further comprises:
rebuilding the reuse library with the one or more additional libraries; and
repeating said building of the executable target software project.

26. The article of manufacture of claim 17 wherein said receiving further comprises:
generating a graphical user interface comprising a list of the names of the blocks of the first set of libraries; and
selecting from the list of the names of the blocks to provide at least one block name of the first set of specified block names.

27. The article of manufacture of claim 17 wherein said method further comprises:
specifying at least one block name via a graphical user interface to provide the first set of specified block names; and
displaying the names of the libraries of the first set of libraries on the graphical user interface.

28. The article of manufacture of claim 26 wherein said method further comprises:
in response to a user activation, generating a wrapper for the at least one block name of the first set of specified block names.
